(19) United States
(12) Patent Application Publication
(10) Pub. No.: US 2022/0317265 A1
(43) Pub. Date: Oct. 6, 2022

(54) LIDAR SYSTEM FOR REDUCING POWER CONSUMPTION AND METHOD OF OPERATING THE SAME

(71) Applicant: CARNAVICOM CO., LTD., Incheon (KR)

(72) Inventors: Sang Hoon LEE, Incheon (KR); Min Woo JUNG, Incheon (KR)

(21) Appl. No.: 17/613,453

(22) PCT Filed: Dec. 14, 2020
(86) PCT No.: PCT/KR2020/018248

§ 371 Date: Feb. 22, 2022

(30) Foreign Application Priority Data
Oct. 16, 2020 (KR) 10-2020-0134595

(51) Int. Cl. G01S 7/4865; G01S 17/42; G01S 17/89; G01S 7/497

(52) U.S. Cl. CPC G01S 7/4865; G01S 17/42; G01S 17/89; G01S 7/497

(57) ABSTRACT

A lidar system for reducing power consumption and method of operating the same are disclosed. The lidar system in a moving object comprises a transmission unit configured to output a light, a reception unit configured to receive a light reflected by an object and a signal processor configured to measure a distance to the object by using the received light. Here, the signal processor controls power consumption of the lidar system by changing a resolution of the transmission unit according to a driving speed or a surrounding environment of the moving object, the transmission unit outputs the light with a resolution determined by the signal processor, and a number of lasers outputted from the transmission unit increases in a field of view FOV as the resolution gets higher.

### TECHNICAL FIELD

The present disclosure relates to a lidar system for reducing power consumption and method of operating the same.

### BACKGROUND ART

Generally, a lidar system outputs constantly a laser, and so power consumption of the lidar system is not good.

### DISCLOSURE

### Technical Problem

The disclosure is to provide a lidar system for reducing power consumption and method of operating the same.

### Technical Solution

A lidar system in a moving object according to one embodiment of the disclosure comprises: a transmission unit configured to output a light; a reception unit configured to receive a light reflected by an object; and a signal processor configured to measure a distance to the object by using the received light. Here, the signal processor controls power consumption of the lidar system by changing a resolution of the transmission unit according to a driving speed or a surrounding environment of the moving object, the transmission unit outputs the light with a resolution determined by the signal processor, and a number of lasers outputted from the transmission unit increases in a field of view FOV as the resolution gets higher.

A lidar system in a moving object according to another embodiment of the disclosure comprises: a transmission unit configured to output a light; a reception unit configured to receive a light reflected by an object; a time measuring unit configured to detect time difference between an output time of the light and a reception time of the reflected light; and a signal processor configured to measure a distance to the object by using the detected time difference. Here, the signal processor controls power consumption by changing a period of a pulse for detecting time difference between a Stop 1 signal having information concerning the output time of the light and a Stop2 signal having information concerning the reception time of the reflected light or time difference between the output time of the light and the reception time of the reflected light, according to a driving speed or a surrounding environment of the moving object.

A method of operating a light system in a moving object according to one embodiment of the disclosure comprises: outputting a light with a first resolution; receiving a light reflected by an object; detecting a distance to the object, a driving speed or a surrounding environment by using the received light; and outputting a light with a second resolution different from the first resolution according to the driving speed or the surrounding environment of the moving object. Here, the light is outputted with a predetermined interval, and the interval is changed when a resolution is changed from the first resolution to the second resolution.

A lidar system and method of operating the same according to the disclosure control an output resolution of a laser depending on a driving speed or a surrounding environment, thereby reducing power consumption.

### BRIEF DESCRIPTION OF DRAWINGS

FIG. 1 is a block diagram illustrating a lidar system according to one embodiment of the disclosure.

FIG. 2 is a view illustrating schematically a process of driving the lidar system in FIG. 1.

FIG. 3 is a view illustrating power consumption of the lidar system in FIG. 1.

FIG. 4 is a view illustrating relation of a horizontal field of view and resolution.

FIG. 5 is a view illustrating a vertical field of view.

FIG. 6 is a view illustrating a process of controlling resolution by moving of a moving object.

FIG. 7 is a view illustrating a process of controlling resolution according to surrounding environment.

FIG. 8 is a view illustrating synthetically a process of controlling resolution according to one embodiment of the disclosure.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

The disclosure relates to a lidar system and method of operating the same. The lidar system may control an output resolution of a light source (for example, a laser) according to a driving speed or a surrounding environment of a moving object such as a vehicle, thereby reducing its power consumption.

Hereinafter, various embodiments of the disclosure will be described in detail with reference to accompanying drawings.

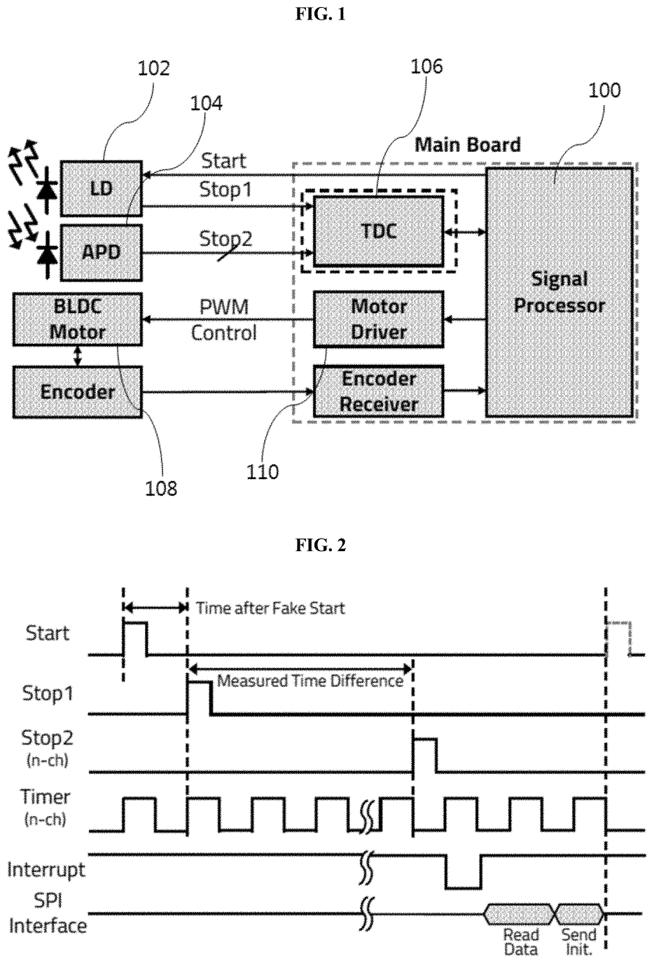

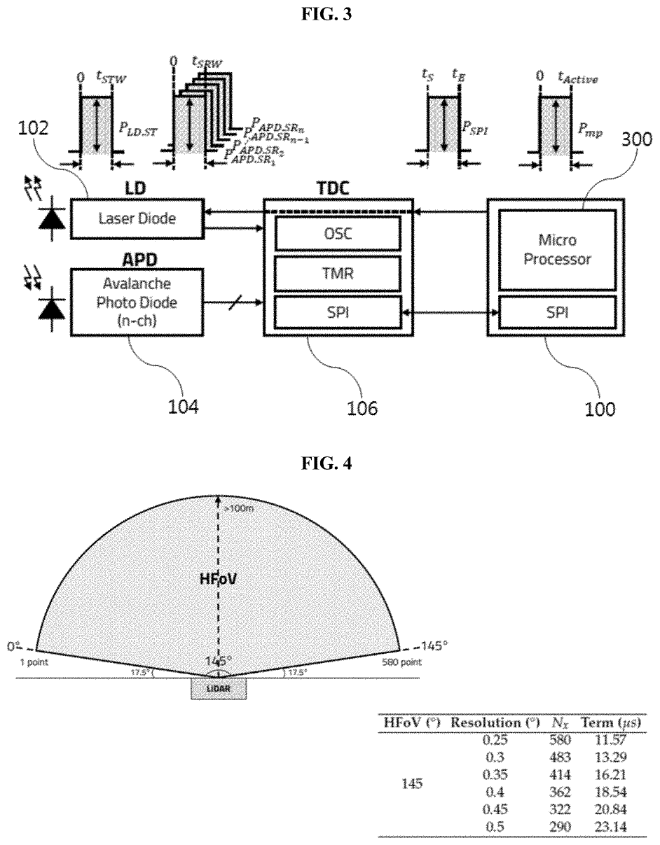

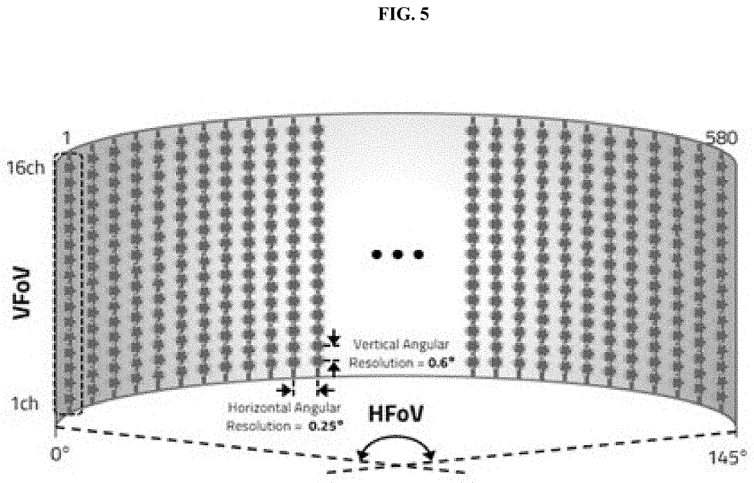

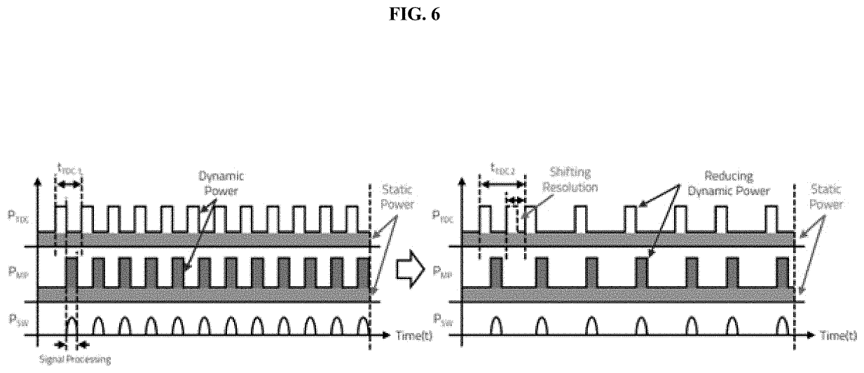

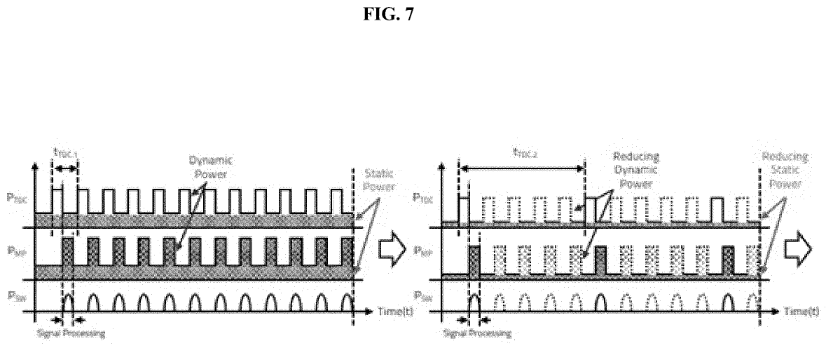

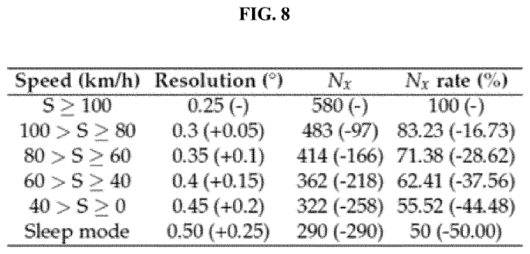

FIG. 1 is a block diagram illustrating a lidar system according to one embodiment of the disclosure, FIG. 2 is a view illustrating schematically a process of driving the lidar system in FIG. 1, and FIG. 3 is a view illustrating power consumption of the lidar system in FIG. 1. FIG. 4 is a view illustrating relation of a horizontal field of view and resolution, FIG. 5 is a view illustrating a vertical field of view, and FIG. 6 is a view illustrating a process of controlling resolution by moving of a moving object. FIG. 7 is a view illustrating a process of controlling resolution according to surrounding environment, and FIG. 8 is a view illustrating synthetically a process of controlling resolution according to one embodiment of the disclosure.

In FIG. 1, the lidar system of the present embodiment may include a signal processor 100, a transmission unit 102, a reception unit 104, a time measuring unit (time-to-digital converter, TDC) 106, a motor 108 and a motor driver 110. Of course, the lidar system may further include an encoder for sensing the rotation speed of the motor 108 and transmitting the sensed result to the signal processor 100 and an encoder receiver.

The transmission unit 102 outputs a light and may be for example a laser generator. That is, the transmission unit 102 may output a laser with a specific resolution according to control of the signal processor 100. In this time, plural lasers are outputted in preset field of view FOV, and the resolution means number of lasers outputted in FOV.

High resolution means that many lasers are outputted in the FOV, and thus an angle between the lasers as a resolution angle may become smaller. Whereas, low resolution indicates that a small number of lasers are outputted, and so the resolution angle becomes larger.

In one embodiment, the transmission unit 102 may transmit a Stop 1 signal including information concerning an output time of the laser to the time measuring unit 106 as shown in FIG. 1 and FIG. 2 when it outputs the laser.

On the other hand, the transmission unit 102 may output the laser to a rotary mirror rotated by the motor 108. As a result, a laser reflected by the rotary mirror may be outputted in the FOV. Of course, the transmission unit 102 may output the laser in the FOV through its rotation without using the rotary mirror.

The reception unit 104 may receive the laser reflected by an object and be for example an avalanche photo diode APD. Here, the reception unit 104 may use a channel, but it may use a plurality of channels, e.g. 16 channels as shown in FIG. 5.

In one embodiment, the reception unit 104 may transmit a Stop2 signal including information concerning a reception time of the reflected laser to the time measuring unit 106 in each of channels, as shown in FIG. 1 and FIG. 2.

The time measuring unit 106 may detect time difference between the output time of the laser and the reception time of the reflected laser based on the Stop1 signal and the Stop2 signal, and transmit the detected result to the signal processor 100.

In one embodiment, the time measuring unit 106 may detect the time difference between the output time of the laser and the reception time of the reflected laser by operating a timer until the Stop2 signal is received from when the Stop 1 signal is received, as shown in FIG. 2. For example, an operation of detecting the time difference may be performed at a rising edge of a pulse. Here, the time measuring unit 106 may detect time difference between a reception time of the Stop 1 signal and a reception time of a Stop2 signal received finally of Stop2 signals when a plurality of Stop2 signals are received.

In one embodiment, the time measuring unit 106 may control the resolution depending on the driving speed or the surrounding environment according to the signal processor 100. Here, the resolution is related to a period of the pulse as shown in FIG. 6 and FIG. 7. Particularly, the period of the pulse becomes shorter according as the resolution gets higher, and the period of the pulse becomes longer according as the resolution gets smaller.

For example, if a driving speed of the moving object is less than 100 km, the period of the pulse may become longer as shown in FIG. 6. As a result, an interval between time points for detection of the time difference increases. Accordingly, a period of processing a signal in the signal processor 100 becomes longer.

For another example, if the moving object comes to a stop, the period of the pulse may become maximally longer as shown in FIG. 7. Accordingly, the interval between the time points for detection of the time difference becomes considerably wider, and thus the period of processing the signal in the signal processor 100 becomes considerably longer.

A period of a pulse in the time measuring unit 106 for detecting the time difference changes according to the driving speed or the surrounding environment. In this time, the resolution of the transmission unit 102 may be preferably changed or keep immediately preceding resolution.

The signal processor 100 may control operations of the transmission unit 102, the reception unit 104, the time measuring unit 106 and the motor driver 110, and it may detect a distance to the object based on the detection result transmitted from the time measuring unit 106.

The signal processor 100 may control the resolution of the transmission unit 102 to reduce power consumption of the lidar system. For this control, the signal processor 100 may include a speed unit, a surrounding detection unit and a micro processor (MP) 300.

In one embodiment, the speed unit may receive information concerning the driving speed of the moving object from a CAN module or a GPS module in the moving object, and the micro processor 300 may control the resolution of the transmission unit 102 based on the received information concerning the driving speed.

If the horizontal field of view HFOV is 145° and the vertical field of view VFOV is 9.6° as shown in FIG. 4 and FIG. 6, the micro processor 300 may maximally increase the resolution to measure precisely approaching object when the driving speed of the moving object to which the lidar system is mounted is more than 100 km, for example it may set a resolution angle to 0.25°. As a result, the transmission unit 102 may output a laser by 580 times in an HFOV when for example the motor, 1 turn, according to the control of the micro processor 300.

The micro processor 300 may set the resolution angle to 0.3° when the driving speed of the moving object is 80 km to 100 km, set the resolution angle to 0.35° when the driving speed is 60 km to 80 km, set the resolution angle to 0.4° when the driving speed is 40 km to 60 km and set the resolution angle to 0.45° when the driving speed is smaller than 40 km. That is, the micro processor 300 may decrease the resolution when the driving speed of the moving object gets smaller, to reduce the power consumption.

The power consumption of the transmission unit 102 may be expressed as sum of power consumptions from when transmission of the laser starts to when the transmission of the laser is finished as shown in following expressions 1 and 3. The power consumption of the reception unit 104 may be expressed as sum of power consumptions from when the laser reflected for each of channels is received to when the reception of the laser is finished as shown in an expression 2.

The power consumption of the time measuring unit 106 may be expressed as sum of power consumptions from when the time measuring unit 106 receives a Stop 1 signal from the transmission unit 102 to when the time measuring unit 106 receives a Stop2 signal from the reception unit 104 as shown in following expression 3. The power consumption of an SPI used for communication between the time measuring unit 106 and the micro processor 300 may be expressed as sum of power consumptions from when data transmission starts between the time measuring unit 106 and the micro processor 300 to when the data transmission is finished as shown in following expression 4. The power consumption of the micro processor 300 may be expressed as sum of power consumptions from when the data is transmitted from the time measuring unit 106 to the micro processor 300 to when signal processing is finished as shown in following expression 5.

As a result, the power consumption of the lidar system when the laser is outputted one time is expressed as following expression 6.

E_{LD}=∫₀^{t}^{_{STW}}P_{LD.ST}(t)dt [Expression 1]

E_{APD}=Σᵢ₌₁ⁿ[∫₀^{t}^{_{SRW}}P_{APD.ST}_{ᵢ}(t)dt][Expression 2]

E_{TDC}=∫₀^{t}^{_{END}}P_{OSC}(t)dt+Σᵢ₌₁ⁿ[∫_{Δ}_{_{LD}}^{Δ}^{_{APD}}iP_{TMR}_{ᵢ}(t)dt ] [Expression 3]

E_{TP}=∫ₜ_{_{S}}^{t}^{_{E}}P_{SPI}(t)dt [Expression 4]

E_{P}=∫₀^{t}^{_{Active}}P_{MP}(t)dt [Expression 5 ]

E_{Total}=E_{LD}+E_{APD}+E_{TDC}+E_{TP}+Eₚ [Expression 6]

It is necessary to increase detection accuracy to prevent accident when the moving object drives rapidly, and thus the lidar system may increase the resolution of the transmission unit 102 and the resolution of the time measuring unit 106. As a result, the power consumption of the lidar system is increased.

The detection accuracy may be considerably low when the moving object drives slowly, and thus the lidar system may decrease the resolution of the transmission unit 102 and the resolution of the time measuring unit 106. In this case, the power consumption of the transmission unit 102, the power consumption of the reception unit 104 or the power consumption of the time measuring unit 106 may reduce as shown in the expression 1 to the expression 6, and to total power consumption of the lidar system may reduce.

In another embodiment, the surrounding detection unit may detect surroundings through the reflected laser or detect the surroundings based on data transmitted from an element of the moving object such as a camera or a black box, etc. located outside the lidar system.

The micro processor 300 may control the power consumption by changing the resolution depending on the detected surrounding environment. For example, in the event that the moving object is stopped or an object is not detected, the micro processor 300 goes into a sleep mode and then control the transmission unit 102 that the transmission unit 102 outputs the laser in a little times and outputs the laser during one rotation of five rotations by the motor 108, thereby reducing the power consumption. For example, the micro processor 300 may control the transmission unit 102 to output the laser by 290 times in the sleep mode, as shown in FIG. 8.

Of course, the micro processor 300 may control the transmission unit 102 not to output the laser while the moving object is stopped.

Or, the micro processor 300 may control the transmission unit 102 to output the laser by approximate 290 times and then control the transmission unit 102 not to output the laser after a certain period of time is lapsed.

On the other hand, the micro processor 100 may change the resolution of the time measuring unit 106 according to the driving speed or the surrounding environment of the moving object. In this time, the resolution of the transmission unit 102 may be generally changed but immediately preceding resolution may be kept.

Briefly, the lidar system of the present embodiment decreases the resolution of the transmission unit 102 when the driving speed of the moving object gets smaller or surrounding object does not exist, thereby reducing the power consumption.

Hereinafter, an operation of the lidar system will be described in detail.

In FIG. 1 and FIG. 2, the micro processor 300 of the signal processor 100 operates in an active mode when startup of the moving object is activated and transmits a start signal for controlling to output the laser with preset resolution to the transmission unit 102 according to the active mode.

Subsequently, the transmission unit 102 outputs the laser with the preset resolution in predetermined FOV in response to the transmitted start signal. In this time, the transmission unit 102 may transmit simultaneously the Stop 1 signal having information concerning an output time of the laser to the time measuring unit 106 when the laser is outputted.

Next, the reception unit 104 may transmit the Stop2 signal having information concerning a reception time of the laser to the time measuring unit 106, when the reception unit 104 receives the laser reflected by the object. Of course, the Stop2 signal is transmitted to the time measuring unit 106 in each of channels when plural channels exist.

Subsequently, the time measuring unit 106 detects the time difference between an output time of the laser and a reception time of the reflected laser by using the Stop 1 signal and the Stop2 signal. Here, the detection of the time difference may be performed by counting time with a timer until from when the Stop 1 signal is received to when the Stop2 signal is received. However, the detection of the time difference is not limited to above method.

Next, the time measuring unit 106 transmits information concerning the time difference to the micro processor 300, and the micro processor 300 detects a distance to the object, existence of the object (surrounding environment), the driving speed, etc. based on the information concerning the time difference. Here, the surrounding environment or the driving speed may be detected by the lidar system or be obtained from an external device such as an CAN module, a camera and so on.

Subsequently, the micro processor 300 may control rotation of the motor 108 by controlling the motor driver 110 according to the distance to the object, the driving speed or the surrounding environment. The motor 108 rotates a rotary mirror for reflecting the laser outputted from the transmission unit 102.

The micro processor 300 may determine a resolution according to the detected driving speed or the detected surrounding environment, and transmit the Start signal to the transmission unit 102, wherein the Start signal controls the transmission unit 102 to output the laser with the determined resolution. In this time, the determined resolution may be different from preset resolution or immediately preceding resolution.

For example, in the event that the driving speed of the moving object is changed from 110 km to 90 km, the micro processor 300 may control the transmission unit 102 to output the laser with resolution smaller than immediately preceding resolution.

For another example, in the event that the object does not exist in the range of 100m, the micro processor 300 may change the active mode to a sleep mode and control the transmission unit 102 to output the laser with resolution smaller than immediately preceding resolution according to the sleep mode.

In another embodiment, the micro processor 300 may change the resolution of the time measuring unit 106 according to the driving speed or the surrounding environment. That is, the micro processor 300 may change the period of the pulse for measuring the time difference between the output time of the laser and the reception time of the reflected laser.

The above steps are repeatedly performed.

Briefly, the lidar system may control the transmission unit 102 or the time measuring unit 106 with resolution different from immediately preceding resolution depending on the driving speed or the surrounding environment.

In above description, the resolution is controlled considering one of the driving speed and the surrounding environment, but it may be controlled considering both of the driving speed and the surrounding environment. For example, the resolution when relatively large numbers of objects exist at surrounding may be higher than that when relatively small number of object exists at surrounding, under the same driving speed.

In another example, the lidar system goes to the sleep mode and changes the resolution when the moving object driving with 30 km is stopped, but it may keep the active mode without going to the sleep mode and keep immediately preceding resolution though the moving object is stopped, if multiple vehicles pass surrounding of the stopped moving object.

In still another example, the resolution may differ depending on day or night, under the same driving speed.

In another embodiment, the laser may be outputted with certain angle, e.g. 0.3° in the range of HFOV according to a specific resolution, or more number of lasers may be outputted in a specific area where vehicle accident occurs in the same resolution. That is, the resolution is the same (for example, 0.3°) in the range of HFOV, but a resolution angle (for example, 0.25°) in the specific area is different from a resolution angle (for example, 0.35°) in other areas.

The detection result of the lidar system may be display on a display device in the moving object, which is not mentioned above. In this time, the detection result may be outputted through only sound to reduce the power consumption when the resolution is more than a reference value, and be outputted through an image when the resolution is smaller than the reference value.

Components in the embodiments described above can be easily understood from the perspective of processes. That is, each component can also be understood as an individual process. Likewise, processes in the embodiments described above can be easily understood from the perspective of components.

Also, the technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present disclosure or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the disclosure, and vice versa.

### INDUSTRIAL APPLICABILITY

The embodiments of the disclosure described above are disclosed only for illustrative purposes. A person having ordinary skill in the art would be able to make various modifications, alterations, and additions without departing from the spirit and scope of the disclosure, but it is to be appreciated that such modifications, alterations, and additions are encompassed by the scope of claims set forth below.

1. A lidar system in a moving object, the lidar system comprising:
a transmission unit configured to output a light;
a reception unit configured to receive a light reflected by an object; and
a signal processor configured to measure a distance to the object by using the received light,
wherein the signal processor controls power consumption of the lidar system by changing a resolution of the transmission unit according to a driving speed or a surrounding environment of the moving object, the transmission unit outputs the light with a resolution determined by the signal processor, and
a number of lasers outputted from the transmission unit increases in a field of view FOV as the resolution gets higher.

2. The lidar system of claim 1, wherein the resolution when the driving speed of the moving object is more than predetermined speed is higher than the resolution when the driving speed is smaller than the predetermined speed.

3. The lidar system of claim 1, wherein the signal processor goes to a sleep mode when the moving object is stopped or the object does not exist in a preset distance from the moving object, and the resolution of the transmission unit is changed to minimum resolution in response to the sleep mode.

4. The lidar system of claim 1, wherein information concerning the driving speed or the surrounding environment is provided from other element of the moving object to the lidar system.

5. The lidar system of claim 1, wherein the light is outputted with preset interval in a horizontal field of view HFOV according to the determined resolution.

6. The lidar system of claim 1, wherein the light is outputted in a horizontal field of view depending on the determined resolution,
and wherein an angle between lights in a specific area in the horizontal field of view is different from an angle between lights in other area.

7. The lidar system of claim 1, further comprising:
a time measuring unit configured to detect time difference between an output time of the light and a reception time of the reflected light,
wherein the signal processor changes a period of a pulse for detecting time difference between a Stop 1 signal having information concerning the output time of the light and a Stop2 signal having information concerning the reception time of the reflected light, according to the driving speed or the surrounding environment.

8. The lidar system of claim 1, wherein the resolution is determined considering both of the driving speed and the surrounding environment,
and wherein the resolution of the transmission unit is changed according to the surrounding environment, though the driving speed belongs in the same range.

9. A lidar system in a moving object, the lidar system comprising:
a transmission unit configured to output a light;
a reception unit configured to receive a light reflected by an object;
a time measuring unit configured to detect time difference between an output time of the light and a reception time of the reflected light; and
a signal processor configured to measure a distance to the object by using the detected time difference,
wherein the signal processor controls power consumption by changing a period of a pulse for detecting time difference between a Stop 1 signal having information concerning the output time of the light and a Stop2 signal having information concerning the reception time of the reflected light or time difference between the output time of the light and the reception time of the reflected light, according to a driving speed or a surrounding environment of the moving object.

10. The lidar system of claim 9, wherein the signal processor increases the period of the pulse when the driving speed of the moving object becomes smaller or the object does not exist in a preset distance from the moving object.

11. A method of operating a light system in a moving object, the method comprising:
outputting a light with a first resolution;
receiving a light reflected by an object;
detecting a distance to the object, a driving speed or a surrounding environment by using the received light; and
outputting a light with a second resolution different from the first resolution according to the driving speed or the surrounding environment of the moving object,
wherein the light is outputted with a predetermined interval, and the interval is changed when a resolution is changed from the first resolution to the second resolution.

12. The method of claim 11, wherein the step of detecting includes:
receiving information concerning an output time of the light when the light is outputted, through a time measuring unit;
receiving information concerning a reception time of the reflected light through the time measuring unit;
detecting time difference between the output time of the light and the reception time of the reflected light through the time measuring unit; and
detecting the distance to the object, the driving speed or the surrounding environment based on the detected time difference.
